(19) United States
(12) Patent Application Publication
(10) Pub. No.: US 2013/0100376 A1
(43) Pub. Date: Apr. 25, 2013

(54) LIQUID CRYSTAL DEVICE, ELECTRONIC APPARATUS, AND PROJECTION TYPE DISPLAY APPARATUS

(71) Applicant: Seiko Epson Corporation, Tokyo (JP)

(72) Inventor: Ayae Sawado, Kai-shi (JP)

(73) Assignee: SEIKO EPSON CORPORATION, Tokyo (JP)

(21) Appl. No.: 13/652,776

(22) Filed: Oct. 16, 2012

(30) Foreign Application Priority Data
Oct. 19, 2011 (JP) 2011-229470

(51) Int. Cl. G02F 1/13357

(52) U.S. Cl. 349/61; 349/96

(57) ABSTRACT

When tilt directions of liquid crystal molecules have an azimuth of 45° or 135° in a counterclockwise direction with respect to the direction in which a wire grid of a wire grid polarization beam splitter extends, a phase difference compensation element in which an optical axis includes refractive index anisotropy of negative uniaxial properties along the thickness direction is inclined in the same direction as the tilt directions, and the phase difference compensation element is inclined in the direction reverse to the tilt directions when tilt directions have an azimuth of 225° or 315°.

### BACKGROUND

1. Technical Field

The present invention relates to a liquid crystal device, an electronic apparatus, and a projection type display apparatus.

2. Related Art

In recent years, a liquid crystal device which uses a VA (Vertical Alignment) mode liquid crystal panel has attracted attention since it is excellent in contrast when viewed from the front surface. The VA mode liquid crystal device includes a liquid crystal layer in which liquid crystal molecules are oriented between a pair of substrates while having a predetermined tilt angle. Moreover, in order to improve viewing angle characteristics, a transmissive liquid crystal device is suggested in which an optical axis is disposed in an orientation in which a phase difference compensation element (for example, a C plate) having refractive index anisotropy of negative uniaxial properties along the thickness direction is inclined with respect to a liquid crystal panel (refer to JP-A-2009-37025).

Meanwhile, in a liquid crystal device of the reflection side, a configuration is suggested in which a direction of a wire grid of a wire grid polarization beam splitter and tilt directions of liquid crystal molecules are set to a predetermined angle to increase contrast when the wire grid polarization beam splitter is disposed in an orientation inclined to a VA mode liquid crystal panel (refer to Japanese Patent No. 4661510).

Here, the inventors have examined with respect to applying the configuration described in JP-A-2009-37025 to the configuration described in Japanese Patent No. 4661510, and as a result of the examination, the inventors have obtained new knowledge in that contrast can be further improved if a combination between the inclination direction of the C plate and the tilt directions of the liquid crystal molecules is optimized. That is, in the related arts, it is considered to be preferable if the C plate is inclined based on an axis line which forms 90° with respect to the tilt directions of the liquid crystal molecules. However, from the examination results of the inventors, in accordance with the tilt directions of the liquid crystal molecules, new knowledge has been obtained according to which contrast can be further improved if the inclination direction of the C plate is optimized.

### SUMMARY

An advantage of some aspects of the invention is to provide a liquid crystal device, an electronic apparatus, and a projection type display apparatus in which the inclination direction of a phase difference compensation element in which an optical axis has reflective index anisotropy of negative uniaxial properties along the thickness direction in accordance with the tilt directions of liquid crystal molecules is optimized, and thereby, contrast can be further improved.

According to an aspect of the invention, there is provided a liquid crystal device including: a liquid crystal panel which includes a first translucent substrate, a second substrate which is disposed so as to be opposite to the first substrate and includes a reflecting layer which reflects light incident from the first substrate toward the first substrate side, and a liquid crystal layer which is provided between the first substrate and the second substrate while having negative dielectric anisotropy and in which liquid crystal molecules are inclined to a normal line direction with respect to a substrate surface of the first substrate and a substrate surface of the second substrate; a wire grid polarization beam splitter which is disposed so as to be inclined with respect to the first substrate and the second substrate in the side of the first substrate opposite to the second substrate; and a phase difference compensation element which is disposed between the first substrate and the wire grid polarization beam splitter and in which an optical axis has refractive index anisotropy of negative uniaxial properties along the thickness direction, wherein when a tilt direction in which the liquid crystal molecules are inclined with respect to the second substrate has an azimuth of 45° or 135° in a counterclockwise direction with respect to a direction in which the wire grid of the wire grid polarization beam splitter extends when the liquid crystal panel is viewed from the wire grid polarization beam splitter side, the phase difference compensation element is disposed in a first inclined orientation which is inclined so that a portion positioned in the tilt direction side based on an axis line forming 90° with respect to the tilt direction approaches the liquid crystal panel and a portion positioned in the side opposite to the tilt direction is separated from the liquid crystal panel, and when the tilt direction has an azimuth of 225° or 315° in a counterclockwise direction with respect to a direction in which the wire grid extends, the phase difference compensation element is disposed in a second inclined orientation which is inclined so that a portion positioned in the tilt direction side based on the axis line is separated from the liquid crystal panel and a portion positioned in the side opposite to the tilt direction approaches the liquid crystal panel.

In the invention, when the phase difference compensation element in which the optical axis includes the refractive index anisotropy of negative uniaxial properties along the thickness direction is disposed in the orientation inclined with respect to the liquid crystal panel, since the inclined orientation of the phase difference compensation element is optimized according to whether or not the tilt direction in which the liquid crystal molecules are inclined with respect to the second substrate has the azimuth of 45° or 135° in a counterclockwise direction with respect to the extension direction of the wire grid or has the azimuth of 225° or 315° in a clockwise direction, contrast can be improved without the decrease of the illuminance at the time of white display.

According to another aspect of the invention, there is provided a liquid crystal device including: a liquid crystal panel which includes a first translucent substrate, a second substrate which is disposed so as to be opposite to the first substrate and includes a reflecting layer which reflects light incident from the first substrate toward the first substrate side, and a liquid crystal layer which is provided between the first substrate and the second substrate while having negative dielectric anisotropy and in which liquid crystal molecules are inclined to a normal line direction with respect to a substrate surface of the first substrate and a substrate surface of the second substrate; a wire grid polarization beam splitter which is disposed so as to be inclined with respect to the first substrate and the second substrate in the side of the first substrate opposite to the second substrate; and a phase difference compensation element which is disposed between the first substrate and the wire grid polarization beam splitter and in which an optical axis has refractive index anisotropy of negative uniaxial properties along the thickness direction, wherein a tilt direction in which the liquid crystal molecules are inclined with respect to the second substrate has an azimuth of 45° or 135° in a counterclockwise direction with respect to a direction in which the wire grid of the wire grid polarization beam splitter extends when the liquid crystal panel is viewed from the wire grid polarization beam splitter side, and the phase difference compensation element is disposed in a first inclined orientation which is inclined so that a portion positioned in the tilt direction side based on an axis line forming 90° with respect to the tilt direction approaches the liquid crystal panel and a portion positioned in the side opposite to the tilt direction is separated from the liquid crystal panel.

According to still another aspect of the invention, there is provided a liquid crystal device including: a liquid crystal panel which includes a first translucent substrate, a second substrate which is disposed so as to be opposite to the first substrate and includes a reflecting layer which reflects light incident from the first substrate toward the first substrate side, and a liquid crystal layer which is provided between the first substrate and the second substrate while having negative dielectric anisotropy and in which liquid crystal molecules are inclined to a normal line direction with respect to a substrate surface of the first substrate and a substrate surface of the second substrate; a wire grid polarization beam splitter which is disposed so as to be inclined with respect to the first substrate and the second substrate in the side of the first substrate opposite to the second substrate; and a phase difference compensation element which is disposed between the first substrate and the wire grid polarization beam splitter and in which an optical axis has refractive index anisotropy of negative uniaxial properties along the thickness direction, wherein a tilt direction in which the liquid crystal molecules are inclined with respect to the second substrate has an azimuth of 225° or 315° in a counterclockwise direction with respect to a direction in which the wire grid of the wire grid polarization beam splitter extends when the liquid crystal panel is viewed from the wire grid polarization beam splitter side, and the phase difference compensation element is disposed in a second inclined orientation which is inclined so that a portion positioned in the tilt direction side based on an axis line forming 90° with respect to the tilt direction is separated from the liquid crystal panel and a portion positioned in the side opposite to the tilt direction approaches the liquid crystal panel.

In the liquid crystal panel, for example, the wire grid may extend so as to be parallel to the substrate surface of the first substrate and the substrate surface of the second substrate.

In the liquid crystal panel, a polarization separation surface on which the wire grid is formed in the wire grid polarization beam splitter may be disposed in an inclined orientation in which a side of 90° in a counterclockwise direction with respect to the direction in which the wire grid extends approaches the liquid crystal panel and a side of 270° in a counterclockwise direction with respect to the direction in which the wire grid extends is separated from the liquid crystal panel when the wire grid polarization beam splitter is viewed from the side opposite to the liquid crystal panel side.

According to still another aspect of the invention, the liquid crystal device of the invention may be used in an electronic apparatus such as a direct viewing type display apparatus or a projection type display apparatus, when the electronic apparatus is the projection type display apparatus, for example, the projection type display apparatus includes: a light source which emits light supplied to the plurality of liquid crystal devices; a color synthesizing optical system which synthesizes each light which is modulated by the plurality of liquid crystal devices; and a projection optical system which projects the light synthesized by the color synthesizing optical system.

In the projection type display apparatus, the plurality of liquid crystal devices includes only one liquid crystal device of a liquid crystal device in which the phase difference compensation element is disposed in the first inclined orientation and a liquid crystal device in which the phase difference compensation element is disposed in the second inclined orientation.

In addition, according to still another aspect of the invention, in the projection type display apparatus, the plurality of liquid crystal devices includes a liquid crystal device in which the phase difference compensation element is disposed in the first inclined orientation and a liquid crystal device in which the phase difference compensation element is disposed in the second inclined orientation, and the tilt directions in the plurality of liquid crystal devices in the image which is projected from the projection optical system are the same azimuth.

According to still another aspect of the invention, the color synthesizing optical system includes a dichroic prism, two liquid crystal devices which makes light incident from the direction relatively opposite to the dichroic prism among the plurality of liquid crystal devices include the liquid crystal device in which the phase difference compensation element is disposed in the first inclined orientation and the liquid crystal device in which the phase difference compensation element is disposed in the second inclined orientation, and the tilt directions in two liquid crystal devices differ by 180°, and in the liquid crystal device which makes the light incident from other direction with respect to the dichroic prism, the tilt directions with respect to the two liquid crystal devices differ by 90°. According to the configuration, since the tilt directions of the liquid crystal molecules in the plurality of liquid crystal devices in the image which is projected from the projection optical system are the same azimuth, a decrease and prevention of coloring when a stripe pattern or the like is displayed can be achieved without a decrease of contrast.

### BRIEF DESCRIPTION OF THE DRAWINGS

The invention will be described with reference to the accompanying drawings, wherein like numbers reference like elements.

FIG. 1 is a schematic configuration diagram of a projection type display apparatus which is electric equipment to which the invention is applied.

FIGS. 2A and 2B are explanatory diagrams of a liquid crystal device which is used in the projection type display apparatus shown in FIG. 1.

FIGS. 3A to 3D are explanatory diagrams of when a phase difference compensation element is disposed in a first inclined orientation in the liquid crystal device to which the invention is applied.

FIGS. 4A to 4D are explanatory diagrams of when a phase difference compensation element is disposed in a second inclined orientation in the liquid crystal device to which the invention is applied.

FIGS. 5A to 5E are explanatory diagrams showing an estimation method of the inclined orientation of the phase difference compensation element in the liquid crystal device according to the invention.

FIGS. 6A and 6B are graphs showing estimation results of the inclined orientation of the phase difference compensation element in the liquid crystal device according to the invention.

FIG. 7 is an explanatory diagram showing Configuration Example 1 of a projection type display apparatus which includes three liquid crystal devices to which the invention is applied.

FIG. 8 is an explanatory diagram showing Configuration Example 2 of the projection type display apparatus which includes three liquid crystal devices to which the invention is applied.

### DESCRIPTION OF EXEMPLARY EMBODIMENTS

Hereinafter, embodiments of the invention will be described with reference to the drawings. In addition, in the drawings referred below, scales of the dimensions may be different from one another according to the component for easy viewing of each component.

### Configuration of Projection Type Display Apparatus

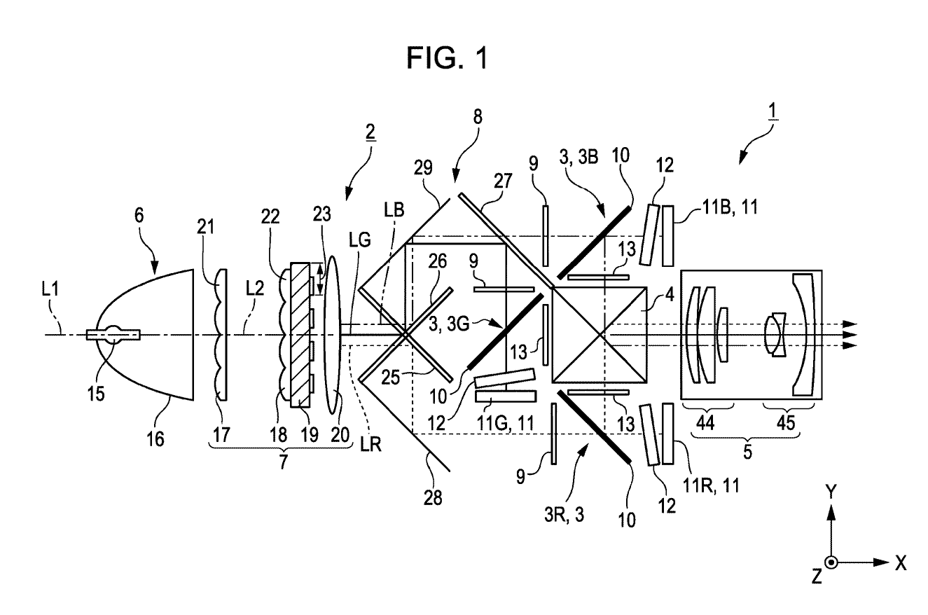

FIG. 1 is a schematic configuration diagram of a projection type display apparatus which is electric equipment to which the invention is applied.

A projection type display apparatus 1 shown in FIG. 1 is a projector which includes three reflection type liquid crystal light valves (reflection type liquid crystal panel). The projection type display apparatus 1 includes an illumination device 2 which emits three color light including red light (R light), green light (G light), blue light (B light), three sets of liquid crystal devices 3R, 3G, and 3B which form an image by each color light, a color synthesizing element 4 (color synthesizing optical system) which synthesizes three color light, and a projection optical system 5 which projects the synthesized light to a surface to be projected (not shown) such as a screen. The illumination device 2 includes a light source 6, an integrator optical system 7, and a color separation optical system 8. The liquid crystal devices 3R, 3G, and 3B include polarizers 9, wire grid polarization beam splitters 10, reflection type liquid crystal panels 11R, 11G, and 11B (light valves), phase difference compensation elements 12, and analyzers 13.

In the projection type display apparatus 1, white light which is emitted from the light source 6 is incident to the integrator optical system 7. The illuminance of the white light which is incident to the integrator optical system 7 becomes uniform and, the white light is emitted so that the polarization state is arranged in a predetermined linearly polarized light. The white light which is emitted from the integrator optical system 7 is separated into each color light of R, G, and B by the color separation optical system 8, and the separated light is incident to the liquid crystal devices 3R, 3G, and 3B in which the sets differ for each color light. The color light which is incident to each of the liquid crystal devices 3R, 3G, and 3B becomes modulated light which is modulated based on the image signals of the image to be displayed. Three modulated light which is emitted from three sets of liquid crystal devices 3R, 3G, and 3B is synthesized by the color synthesizing element 4 (color synthesizing optical system), becomes polychromatic light, and is incident to the projection optical system 5. The polychromatic light which is incident to the projection optical system 5 is projected to the surface to be projected such as a screen. In this way, the image of a full color is displayed on the surface to be projected.

In the projection type display apparatus 1 which is configured in this way, the light source 6 includes a light source lamp 15 and a parabolic reflector 16. The light which is emitted from the light source lamp 15 is reflected in one direction by the parabolic reflector 16, becomes an approximately luminous flux, and is incident to the integrator optical system 7 as a light source light. For example, the light source lamp 15 includes a metal halide lamp, a xenon lamp, a high pressure mercury lamp, a halogen lamp, or the like. Instead of the parabolic reflector 16, the reflector may include an oval reflector, a spherical surface reflector, or the like. A collimator lens which collimates the light emitted from the reflector may be used according to the shape of the reflector.

The integrator optical system 7 includes a first lens array 17, a second lens array 18, a polarization conversion element 19, and a superimposing lens 20. The first lens array 17 includes a plurality of microlenses 21 which are arranged in a surface approximately perpendicular to an optical axis L1 of the light source 6. Similar to the first lens array 17, the second lens array 18 includes a plurality of microlenses 22. The microlenses 21 and 22 are arranged in a matrix form respectively, and the plane shapes of the microlenses in the plane perpendicular to the optical axis L1 becomes a shape (approximately rectangle) similar to the illuminated regions of the liquid crystal panels 11R, 11G, and 11B. The illuminated region is a region in which a plurality of pixels are arranged in a matrix form in the liquid crystal panels 11R, 11G, and 11B and which substantially contributes the display.

The polarization conversion element 19 includes a plurality of polarization conversion units 23. The detail configuration of each of the polarization conversion units 23 is omitted, and each of the units includes a polarization separation film, ½ phase plate, and a reflection mirror. Each microlens 21 of the first lens array 17 corresponds to each microlens 22 of the second lens array 18 one to one. Each microlens 22 of the second lens array 18 corresponds to each polarization conversion unit 23 of the polarization conversion element 19 one to one.

The light of the light source which is incident to the integrator optical system 7 is spatially divided in and is incident to the plurality of microlenses 21 of the first lens array 17, and the light is collected for every luminous flux which is incident to the microlenses 21. The light of the light source which is collected by each microlens 21 is imaged on the microlens 22 of the second lens array 18 corresponding to the microlens 21. That is, a secondary light source image is formed on each of the plurality of microlenses 22 of the second lens array 18. The light from the secondary light source image which is formed on the microlens 22 is incident to the polarization conversion unit 23 corresponding to the microlens 22.

The light which is incident to the polarization conversion unit 23 is separated into P polarized light and S polarized light with respect to the polarization separation film. After one polarized light (for example, S polarized light) which is separated is reflected at a reflecting mirror, the polarized light passes through the ½ phase plate, and thereby, a polarization state is converted, and the polarized light is arranged to the other polarized light (for example, P polarized light). Here, the polarization state of the light passing through the polarization conversion unit 23 is arranged to the polarization state in which the light transmits the polarizer 9 described below. The light which is emitted from the plurality of polarization conversion units 23 is superimposed on the illuminated regions of the liquid crystal panels 11R, 11G, and 11B by the superimposing lens 20. Each luminous flux which is spatially divided by the first lens array 17 illuminates the approximately entire region of the illuminated region, and thereby, the illuminance distribution is averaged, and the illuminance on the illuminated region is equalized.

The color separation optical system 8 includes a first dichroic mirror 25 which includes a wavelength selection surface, a second dichroic mirror 26, a third dichroic mirror 27, a first reflecting mirror 28, and a second reflecting mirror 29. The first dichroic mirror 25 includes spectral characteristics which reflects red light LR and transmits green light LG and blue light LB. The second dichroic mirror 26 includes spectral characteristics which transmits the red light LR and reflects the green light LG and the blue light LB. The third dichroic mirror 27 includes spectral characteristics which reflects the green light LG and transmits the blue light LB. The first dichroic mirror 25 and the second dichroic mirror 26 are disposed that the wavelength selection surfaces are approximately perpendicular to each other respectively and the angle between each wavelength selection surface and the optical axis L2 of the integrator optical system 7 is approximately 45°.

The red light LR, the green light LG, and the blue light LB which are included in the light of the light source incident to the color separation optical system 8 are separated as follows and are incident to the liquid crystal devices 3R, 3G, and 3B corresponding to for each separated color. That is, after the red light LR is transmitted to the second dichroic mirror 26 and is reflected by the first dichroic mirror 25, the red light is reflected by the first reflecting mirror 28 and incident to the liquid crystal device 3R for the red light. After the green light LG is transmitted to the first dichroic mirror 25 and is reflected by the second dichroic mirror 26, the red light is reflected by the second reflecting mirror 29, is reflected by the third dichroic mirror 27, and is incident to the liquid crystal device 3G for the green light. After the blue light LB is transmitted to the first dichroic mirror 25 and is reflected by the second dichroic mirror 26, the red light is reflected by the second reflecting mirror 29, is transmitted to the third dichroic mirror 27, and is incident to the liquid crystal device 3B for the blue light. Each color light which is modulated by each of the liquid crystal devices 3R, 3G, 3B is incident to the color synthesizing element 4.

The color synthesizing element 4 includes a dichroic prism. The dichroic prism has a structure in which four triangular column prisms are bonded to one another. The surfaces which are bonded to one another in the triangular column prisms become inner surfaces of the dichroic prisms. A mirror surface in which the red light LR is reflected and the green light LG is transmitted and a mirror surface in which the blue light LB is reflected and the green light LG is transmitted are formed so as to be perpendicular to each other in the inner surface of the dichroic prism. The green light LG incident to the dichroic prism goes straight through the mirror surface and is emitted. The red light LR and the blue light LB incident to the dichroic prism are reflected or transmitted selectively by the mirror surface, and are emitted in the same direction as the emission direction of the green color LG. In this way, three color light (images) is superimposed and synthesized, and the synthesized color light is enlarged and projected to a screen or the like by the projection optical system 5. The projection optical system 5 includes a first lens group 44 and a second lens group 45.

### Configurations of Liquid Crystal Devices 3R, 3G, and 3B

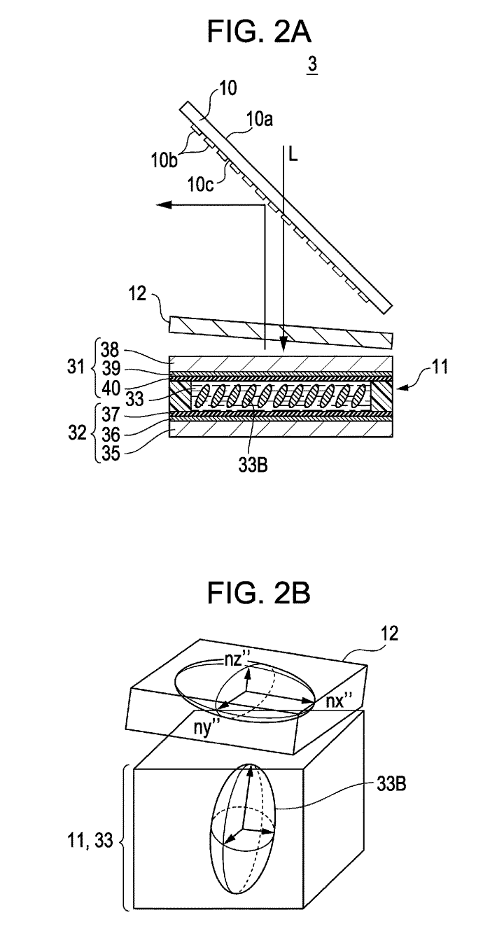

FIGS. 2A and 2B are explanatory diagrams of the liquid crystal device 3 which is used in the projection type display apparatus 1 shown in FIG. 1, and FIGS. 2A and 2B are the explanatory diagram which shows the configuration of the liquid crystal device 3 and the explanatory diagram of the phase difference compensation element (C plate) respectively.

In FIGS. 1 and 2A, all the liquid crystal devices 3R, 3G, 3B are unitized and have the similar configurations as one another. Moreover, for example, the unitized three liquid crystal devices 3R, 3G, and 3B are bonded to three light incident surfaces of the color synthesizing element 4. Here, since the configurations of the liquid crystal devices 3R, 3G, and 3B are the same to one another, hereinafter, the liquid crystal devices 3R, 3G, and 3B and the liquid crystal panels 11R, 11G, and 11B will be described as the liquid crystal device 3 and the liquid crystal panel 11 while R, G, B indicating the corresponding colors are not given to them.

The liquid crystal device 3 includes the polarizer 9 (an incidence side polarization plate), the wire grid polarization beam splitter 10, the liquid crystal panel 11, the phase difference compensation element 12, and the analyzer 13 (emission side polarization plate). In the liquid crystal device 3, the light L which is separated from the light of the light source is incident to the polarizer 9. The polarizer 9 transmits the linearly polarized light which oscillates in a predetermined direction, and the transmission axis is set so that the P polarized light is transmitted with respect to a polarization separation surface 10c of the wire grid polarization beam splitter 10. Hereinafter, the P polarized light with respect to the polarization separation surface 10c of the wire grid polarization beam splitter 10 is simply referred to as a P polarized light, and the S polarized light with respect to the polarization separation surface 10c of the wire grid polarization beam splitter 10 is simply referred to as a S polarized light. As described above, the polarization state of the light of the light source which transmits the integrator optical system 7 is arranged in the P polarized light, the substantially entire light L transmits the polarizer 9 and is incident to the wire grid polarization beam splitter 10.

For example, the wire grid polarization beam splitter 10 includes a glass substrate 10a and wire grids 10b which are configured of a plurality of metal wires and the like formed on the glass substrate 10a. All the plurality of wire grids 10b extend in one direction, are separated so as to be approximately parallel to one another, and are formed on the glass substrate 10a. A main surface of the glass substrate 10a on which the plurality of wire grids 10b are formed becomes a polarization separation surface 10c, the extension direction of the plurality of wire grids 10b is a reflection axis direction, and the disposition direction of the plurality of wire grids 10b is a transmission axis direction.

The polarization separation surface 10c forms an approximately 45° with respect to the center axis of the light L incident to the polarization separation surface 10c. Among the light L incident to the polarization separation surface 10c, the S polarized light in which the polarization direction coincides with the reflection axis direction is reflected by the polarization separation surface 10c, and the P polarized light in which the polarization direction coincides with the transmission axis direction transmits the polarization separation surface 10c. Since the light L substantially becomes the P polarized light due to the effects of the polarization conversion element 19 and the polarizer 9 of the integrator optical system 7, the substantially entire light L transmits the polarization separation surface 10c of the wire grid polarization beam splitter 10 and is incident to the liquid crystal panel 11. Moreover, in consideration of heat resistance and the like, it is preferable that the polarizer 9 and the analyzer 13 be also configured of a wire grid type polarization plate.

### Configuration of Liquid Crystal Panel 11

As shown in FIG. 2A, the liquid crystal panel 11 is a reflection type liquid crystal panel, and the liquid crystal mode is a vertical orientation (Vertical Alignment) mode. The liquid crystal panel 11 includes an opposed substrate 31 (first substrate), an element substrate 32 (second substrate) which is disposed so as to be opposite to the opposed substrate 31, and a liquid crystal layer 33 which is interposed between these two substrates. The liquid crystal layer 33 is configured of a liquid crystal material in which the dielectric anisotropy is negative.

A plurality of gate lines and a plurality of source lines are disposed so as to be perpendicular to one another on a substrate main body 35 which configures the element substrate 32, and pixels which includes TFTs and pixel electrodes 36 are provided in each of a plurality of positions corresponding to intersections of the gate lines and the source lines. Moreover, in FIG. 2A, the illustrations of the gate lines, the source lines, the TFT, and the like, which are components of the lower layer side than the pixel electrode 36, are omitted. For example, the pixel electrode 36 is configured of metals having a high optical reflectance such as aluminum, silver, and alloy thereof, and functions as a reflection electrode (reflection layer). Meanwhile, a common electrode 39 which is formed of a transparent conductive material such as Indium Tin Oxide (hereinafter, abbreviated as ITO) is provided on the substrate main body 38 which configures the opposed substrate 31.

An oriented film 37 is formed on the pixel electrode 36 of the element substrate 32. Similarly, an oriented film 40 is formed on the common electrode 39 of the opposed substrate 31. These oriented films 37 and 40 are formed by performing vacuum deposition of silicon oxide (SiO₂). For example, the vacuum degree at the time of the vacuum deposition is set to 5×10³ Pa, and the temperature of the substrate is set to 100° C. Since the oriented films 37 and 40 impart anisotropy, the deposition is performed in a direction which is inclined 45° from the substrate surface. Accordingly, the column (columnar structure body) of the silicon oxide is grown in a direction which is inclined 70° from the substrate surface in the direction which is the same as the deposition azimuth. The oriented film 37 on the element substrate 32 and the oriented film 40 on the opposed substrate 31 are disposed so that each of the orientation directions is anti-parallel to each other. According to the above-described oriented films 37 and 40, the liquid crystal molecules 33B of the liquid crystal layer 33 are inclined in the normal line direction with respect to the substrate surface of the opposed substrate 31 and the substrate surface of the element substrate 32 and are oriented so as to form a predetermined pre-tilt angle.

In the liquid crystal device 3 of the present embodiment, for example, the opposed substrate 31 and the element substrate 32 are held with a gap of 2.1 μm and bonded to each other, liquid crystals having negative dielectric anisotropy (Δn=0.216: wavelength 589 nm) are injected therebetween, and crystal cells are formed. The liquid crystal molecules 33B are oriented so as to be inclined 4° from the normal line direction of the substrate surface in the same direction as the inclination directions (tilt direction) of the columns of the oriented films 37 and 40 between the oriented films 37 and 40. Since the pre-tilt angle is imparted in this way, the liquid crystal molecules 33B have optical anisotropy, and the liquid crystal layer 33 which includes the liquid crystal molecules 33B has a retardation axis.

When the liquid crystal molecules 33B are viewed from the normal line direction of the opposed substrate 31 and the element substrate 32, the retardation axis of the liquid crystal layer 33 coincides with the longitudinal direction of the long axis of the elliptical liquid crystal molecules 33B which is projected on the opposed substrate 31 or the element substrate 32. Moreover, in the liquid crystal molecule 33B, one side of the long axis is inclined to the other side due to the imparted pre-tilt angle. In the embodiment, the liquid crystal molecules 33B are gradually inclined to the normal line of the element substrate 32 from the element substrate 32 side toward the opposed substrate 31 side, and the direction which is inclined when viewed from the element substrate 32 is referred to as a tilt direction (the direction of the orientation axis).

### Configuration of Phase Difference Compensation Element 12

As shown in FIG. 2A, the phase difference compensation element 12 is disposed on the optical path between the wire grid polarization beam splitter 10 and the liquid crystal panel 11. That is, the wire grid polarization beam splitter 10 is disposed in the side opposite to the element substrate 32 of the opposed substrate 31 of the liquid crystal panel 11, and the phase difference compensation element 12 is disposed on the optical path between the opposed substrate 31 and the wire grid polarization beam splitter 10. In the liquid crystal device 3, the light L which transmits the wire grid polarization beam splitter 10 sequentially transmits the phase difference compensation element 12, the opposed substrate 31 of the liquid crystal panel 11. In addition, after the light is incident to the liquid crystal layer 33, the light is reflected on the element substrate 32 and is returned. At that time, the light L becomes modulated light which is modulated while transmitting the liquid crystal layer 33, and transmits the opposed substrate 31 and the phase difference compensation element 12 again.

In FIG. 2B, the phase difference compensation element 12 is the C plate in which the optical axis has refractive index anisotropy of negative uniaxial properties along the thickness direction. The phase difference compensation element 12 is formed of a multilayer film in which a high refractive index layer and a low refractive index layer are alternately laminated on the substrate by a sputtering method or the like, and is a birefringence body in which the optical axis has the refractive index anisotropy of uniaxial negative properties along the thickness direction. The phase difference compensation element 12 includes the optical axis perpendicular to the surface and compensates the phase difference of the light in the inclination direction which is emitted from the liquid crystal panel 11. The high refractive index layer is formed of TiO₂, ZrO₂, or the like which is a dielectric having a relatively high refractive index, and the low refractive index layer is formed of SiO₂, MgF₂, or the like which is a dielectric having a relatively low refractive index. In the phase difference compensation element 12 having the above-described configuration, in order to prevent the reflection and the interference between each layer of the light transmitting the element 12, it is preferable that the thickness of each refractive index layer be thinned.

In the phase difference compensation element 12, as shown by a refractive index ellipsoid, the relationship of the refractive indices in each direction is nx″=ny″>nz″, and since the element 12 is isotropic with respect to the light incident so as to be parallel to the optical axis, the phase difference can be compensated. On the other hand, among the light which is emitted from the liquid crystal panel 11, the phase difference of the light which has an inclined component, that is, the phase difference of the inclined component of the VA mode liquid crystal is optically compensated. In addition, the phase difference compensation element 12 does not need to completely satisfy nx″=ny″ and may have slightly phase-differences. Specifically, the front phase difference value may be approximately 0 nm to 3 nm.

As this kind of phase difference compensation element 12, a phase difference Rth in the thickness direction is preferably 100 nm or more and 300 nm or less, and is more preferably 180 nm. Here, the phase difference Rth in the thickness direction is defined by the following equation.

Rth={(nx″+ny″)/2−nz″}×d

Here, nx″ and ny″ represent the main refractive indices in the surface direction, and nz″ represents the main refractive index in the thickness direction. Moreover, d is the thickness of the phase difference compensation element 12. Accordingly, if the phase difference compensation element 12 is inclined and disposed so that the optical axis of the phase difference compensation element 12 is parallel to the pre-tilt directions of the liquid crystal molecules 33B, the front phase difference of the liquid crystal panel 11 can be compensated by the phase difference compensation element 12.

### Detailed Description of Liquid Crystal Device 3

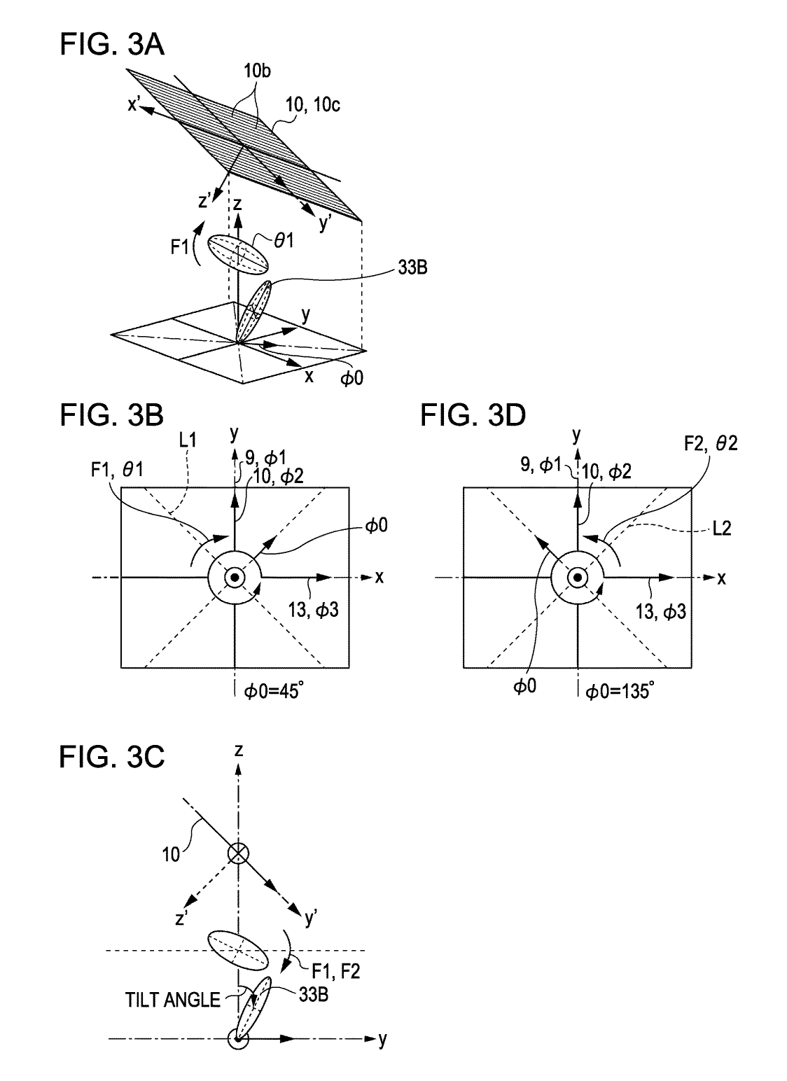

FIGS. 3A to 3D are explanatory diagrams when the phase difference compensation element 12 is disposed in a first inclined orientation in the liquid crystal device 3 to which the invention is applied, and FIGS. 3A to 3D are the explanatory diagram showing the direction or the orientation of each element, and the like when the phase difference compensation element 12 is disposed in the first inclined orientation, the explanatory diagram showing the positional relationship of the axis or the like of each element when the azimuth in the tilt direction is 45° in a counterclockwise direction, the explanatory diagram showing the orientation of the phase difference compensation element 12, and the explanatory diagram showing the positional relationship of the axis or the like of each element when the azimuth in the tilt direction is 135° in a counterclockwise direction respectively.

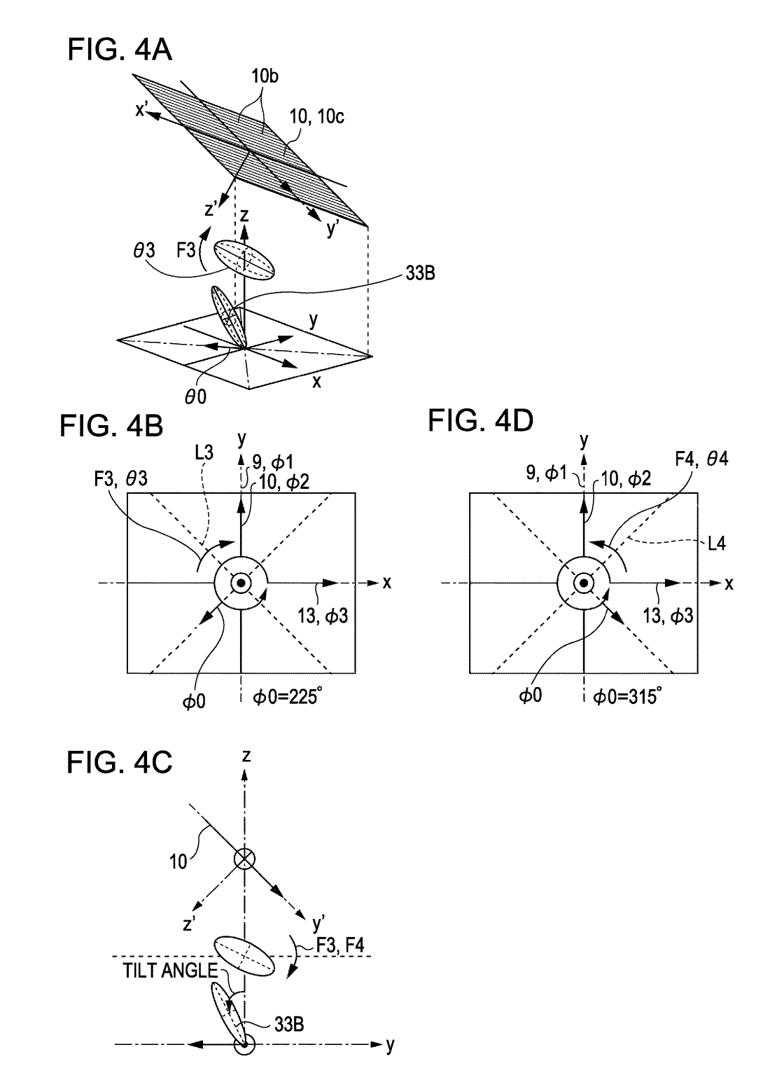

FIGS. 4A to 4D are explanatory diagrams when the phase difference compensation element 12 is disposed in a second inclined orientation in the liquid crystal device 3 to which the invention is applied, and FIGS. 4A to 4D are the explanatory diagram showing the direction or the orientation of each element, and the like when the phase difference compensation element 12 is disposed in the second inclined orientation, the explanatory diagram showing the positional relationship of the axis or the like of each element when the azimuth in the tilt direction is 225° in a counterclockwise direction, the explanatory diagram showing the orientation of the phase difference compensation element 12, and the explanatory diagram showing the positional relationship of the axis or the like of each element when the azimuth in the tilt direction is 315° in a counterclockwise direction respectively.

Moreover, in FIGS. 3A to 4D, the directions which are perpendicular to each other in the in-plane direction of the liquid crystal panel 11 are shown by an x direction and a y direction, and the normal line direction with respect to the liquid crystal panel 11 is shown by a z direction. Moreover, in FIGS. 3A to 4D, the directions which are perpendicular to each other in the in-plane direction of the polarization separation surface 10c of the wire grid polarization beam splitter 10 are shown by an x′ direction and a y′ direction, and the normal line direction with respect to the polarization separation surface 10c is shown by a z′ direction.

In the liquid crystal device 3 described with reference to FIGS. 2A and 2B, for example, as shown in FIGS. 3A and 3B, in the wire grid polarization beam splitter 10 (WG-PBS), the extension direction of the wire grid 10b is parallel to the liquid crystal panel 11, and the transmission axis of the analyzer 13 also is parallel to the axis which is optically projected to the liquid crystal panel 11. Thereby, the x direction of the liquid crystal panel 11 is the same as the x′ direction of the wire grid polarization beam splitter 10, in the invention, the azimuth of each axis will be described according to the angle in a counterclockwise direction in x direction when viewed from the side of the wire grid polarization beam splitter 10 or the side opposite to the liquid crystal panel 11 with respect to the wire grid polarization beam splitter 10.

Accordingly, the azimuth φ3 of the transmission axis of the analyzer 13 is 0°, and the azimuth φ1 of the transmission axis of the wire grid polarization beam splitter 10 and the azimuth φ2 of the transmission axis of the polarizer 9 are 90° in a counterclockwise direction. Moreover, the polarization separation surface 10c of the wire grid polarization beam splitter 10 is disposed in an inclined orientation in which the side of 90° in a counterclockwise direction approaches the liquid crystal panel 11 and the side of 270° in a counterclockwise direction is separated from the liquid crystal panel 11.

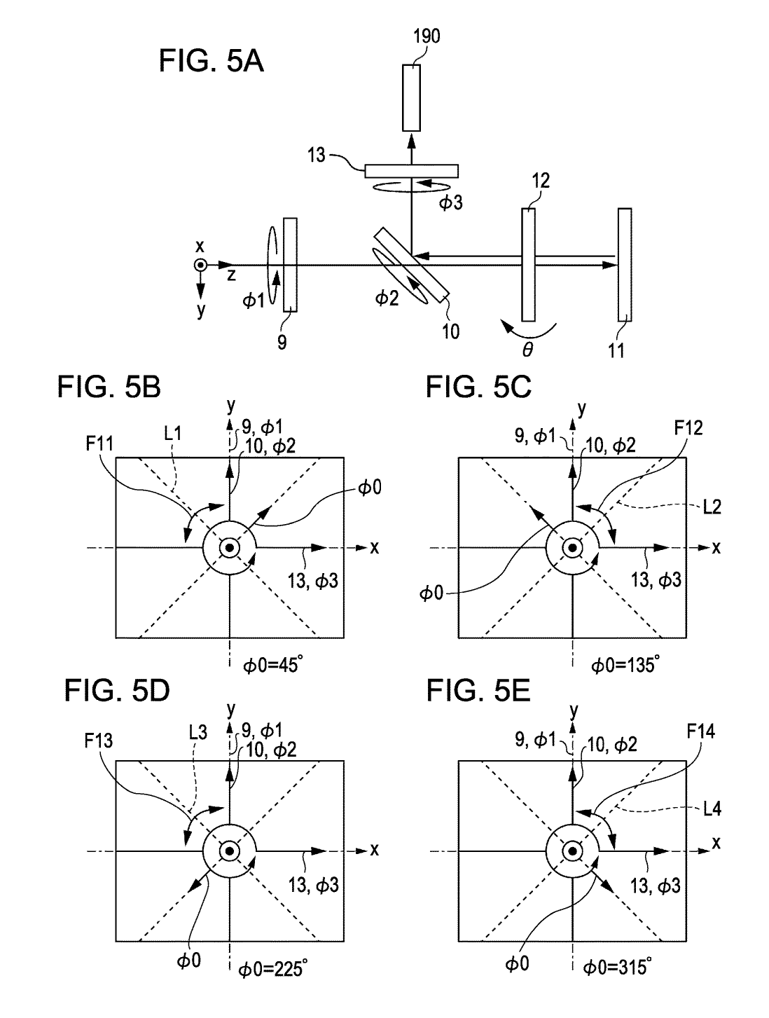

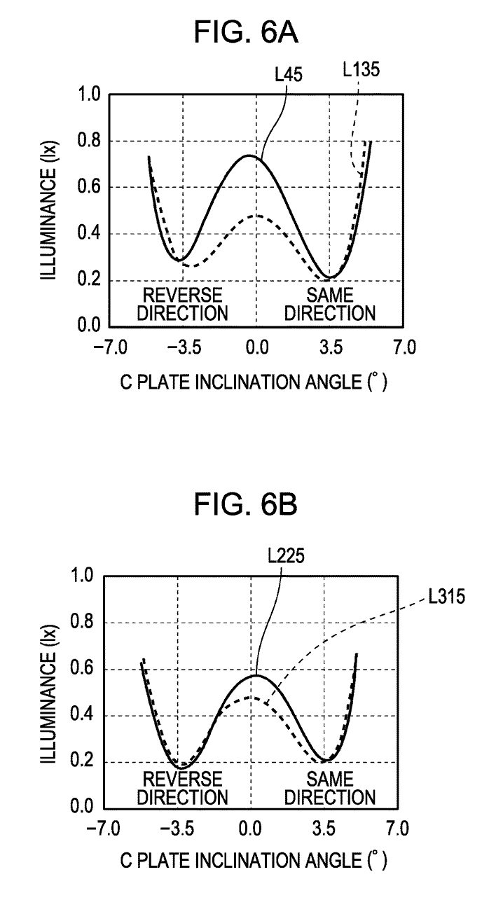

Here, in the liquid crystal panel 11 shown in FIGS. 3A and 3B, the azimuth angle φ0 in the tilt directions (orientation axis) of the liquid crystal molecules 33B with respect to the second substrate 32 is 45° in a counterclockwise direction. In this case, the phase difference compensation element 12 (C plate) is configured as shown in FIGS. 3B and 3C based on examination results described below with reference to FIGS. 5A to 6B. Specifically, as shown in an arrow F1, the phase difference compensation element 12 (C plate) is disposed in the first inclined orientation of being inclined by an angle θ1 from the horizontal orientation parallel to the liquid crystal panel 11 so that the portion which is positioned in the tilt direction side based on an axis line L2 forming 90° in the tilt direction (the azimuth angle φ0 of the orientation axis) approaches the liquid crystal panel 11 and the portion which is positioned in the side opposite to the tilt direction is separated from the liquid crystal panel 11. That is, the phase difference compensation element 12 is disposed in the inclined orientation in which the side of 45° in a counterclockwise direction approaches the liquid crystal panel 11 and the side of 225° in a counterclockwise direction is separated from the liquid crystal panel 11. In the embodiment, the angle θ1 is 3.6°.

Moreover, in the liquid crystal panel 11 shown in FIG. 3D, the azimuth angle φ0 in the tilt directions (orientation axis) of the liquid crystal molecules 33B with respect to the second substrate 32 is 135° in a counterclockwise direction. In this case, the phase difference compensation element 12 (C plate) is configured as shown in FIGS. 3C and 3D based on examination results described below with reference to FIGS. 5A to 6B. Specifically, as shown in an arrow F2, the phase difference compensation element 12 (C plate) is disposed in the first inclined orientation of being inclined by an angle θ2 from the horizontal orientation parallel to the liquid crystal panel 11 so that the portion which is positioned in the tilt direction side based on an axis line L1 forming 90° in the tilt direction (the azimuth angle φ0 of the orientation axis) approaches the liquid crystal panel 11 and the portion which is positioned in the side opposite to the tilt direction is separated from the liquid crystal panel 11. That is, the phase difference compensation element 12 is disposed in the inclined orientation in which the side of 135° in a counterclockwise direction approaches the liquid crystal panel 11 and the side of 315° in a counterclockwise direction is separated from the liquid crystal panel 11. In the embodiment, the angle θ2 is 3.2°.

On the other hand, in the liquid crystal panel 11 shown in FIGS. 4A and 4B, the azimuth angle φ0 in the tilt directions (orientation axis) of the liquid crystal molecules 33B with respect to the second substrate 32 is 225° in a counterclockwise direction. In this case, the phase difference compensation element 12 (C plate) is configured as shown in FIGS. 4B and 4C based on examination results described below with reference to FIGS. 5A to 6B. Specifically, as shown in an arrow F3, the phase difference compensation element 12 (C plate) is disposed in the second inclined orientation of being inclined by an angle θ3 from the horizontal orientation parallel to the liquid crystal panel 11 so that the portion which is positioned in the tilt direction side based on an axis line L3 forming 90° in the tilt direction (the azimuth angle φ0 of the orientation axis) is separated from the liquid crystal panel 11 and the portion which is positioned in the side opposite to the tilt direction approaches the liquid crystal panel 11. That is, the phase difference compensation element 12 is disposed in the inclined orientation in which the side of 225° in a counterclockwise direction is separated from the liquid crystal panel 11 and the side of 45° in a counterclockwise direction is separated from the liquid crystal panel 11. In the embodiment, the angle θ3 is 3.4°.

Moreover, in the liquid crystal panel 11 shown in FIG. 4D, the azimuth angle φ0 in the tilt directions (orientation axis) of the liquid crystal molecules 33B with respect to the second substrate 32 is 315° in a counterclockwise direction. In this case, the phase difference compensation element 12 (C plate) is configured as shown in FIGS. 4C and 4D based on examination results described below with reference to FIGS. 5A to 6B. Specifically, as shown in an arrow F4, the phase difference compensation element 12 (C plate) is disposed in the second inclined orientation of being inclined by an angle θ4 from the horizontal orientation parallel to the liquid crystal panel 11 so that the portion which is positioned in the tilt direction side based on an axis line L4 forming 90° in the tilt direction (the azimuth angle φ0 of the orientation axis) is separated from the liquid crystal panel 11 and the portion which is positioned in the side opposite to the tilt direction approaches the liquid crystal panel 11. That is, the phase difference compensation element 12 is disposed in the inclined orientation in which the side of 315° in a counterclockwise direction is separated from the liquid crystal panel 11 and the side of 135° in a counterclockwise direction approaches the liquid crystal panel 11. In the embodiment, the angle θ4 is 3.4°.

### Estimation Results

FIGS. 5A to 5E are explanatory diagrams showing an estimation method of the inclined orientation of the phase difference compensation element 12 in the liquid crystal device 3 according to the invention, and FIGS. 5A to 5E are the explanatory diagram of an estimation device, the explanatory diagram showing the estimation method when the tilt direction (the azimuth angle φ0 of the orientation axis) is 45°, the explanatory diagram showing the estimation method when the tilt direction (the azimuth angle φ0 of the orientation axis) is 135°, the explanatory diagram showing the estimation method when the tilt direction is 225°, and the explanatory diagram showing the estimation method when the tilt direction is 315° respectively. FIGS. 6A and 6B are graphs showing estimation results of the inclined orientation of the phase difference compensation element 12 in the liquid crystal device 3 according to the invention, and FIGS. 6A and 6B are the graph showing the illuminance at the time of black display when the tilt direction is 45° and 135° and the graph showing the illuminance at the time of black display when the tilt direction is 225° and 315° respectively.

Moreover, in FIG. 6A, a solid line L45 indicates the illuminance when the tilt direction is 45° and a dotted line L135 indicates the illuminance when the tilt direction is 135°, and in FIG. 6B, a solid line L225 indicates the illuminance when the tilt direction is 225° and a dotted line L315 indicates the illuminance when the tilt direction is 315°.

Moreover, in the estimation described with reference to FIGS. 5A to 6B, the inclination angle when the phase difference compensation element 12 is inclined in the same direction as the tilt directions (the azimuth angle φ0 of the orientation axis) of the liquid crystal molecules 33B is given as “positive (the same direction)”, and the inclination angle when the phase difference compensation element 12 is inclined in the direction reverse to the tilt directions (the azimuth angle φ0 of the orientation axis) of the liquid crystal molecules 33B is given as “negative (the reverse direction)”.

As shown in FIG. 5A, in the embodiment, similar to the liquid crystal device 3 described with reference to FIG. 1, the polarizer 9 (incidence side polarization plate), the wire grid polarization beam splitter 10, the liquid crystal panel 11, the phase difference compensation element 12, and the analyzer 13 (emission side polarization plate) are disposed, and the light which transmits the analyzer 13 is detected by a detector 190. At that time, as shown in FIGS. 5B to 5E, the azimuth of the transmission axis φ1 of the polarizer 9, the azimuth of the transmission axis φ2 of the wire grid polarization beam splitter 10, the azimuth angle φ0 of the tilt directions (orientation axis) of the liquid crystal molecules 33B in the liquid crystal panel 11, and the azimuth of the transmission axis φ3 of the analyzer 13 have the configurations similar to the configurations which are described with reference to FIGS. 3A to 4D.

In addition, as shown in FIG. 5B, when the tilt direction is 45° in a counterclockwise direction, as shown in an arrow F11, the phase difference compensation element 12 is inclined around the axis line L1 which forms the angle of 90° with respect to the tilt direction, black display and white display are performed, and the illuminance at this time is detected by the detector 190. The detected results (illuminance) are shown in Table 1 and FIG. 6A.

Moreover, as shown in FIG. 5C, when the tilt direction is 135° in a counterclockwise direction, as shown in an arrow F12, the phase difference compensation element 12 is inclined around the axis line L2 which forms the angle of 90° with respect to the tilt direction, black display and white display are performed, and the illuminance at this time is detected by the detector 190. The detected results (illuminance) are shown in Table 1 and FIG. 6A.

In addition, as shown in FIG. 5D, when the tilt direction is 225° in a counterclockwise direction, as shown in an arrow F13, the phase difference compensation element 12 is inclined around the axis line L3 which forms the angle of 90° with respect to the tilt direction, black display and white display are performed, and the illuminance at this time is detected by the detector 190. The detected results (illuminance) are shown in Table 1 and FIG. 6B.

In addition, as shown in FIG. 5E, when the tilt direction is 315° in a counterclockwise direction, as shown in an arrow F14, the phase difference compensation element 12 is inclined around the axis line L4 which forms the angle of 90° with respect to the tilt direction, black display and white display are performed, and the illuminance at this time is detected by the detector 190. The detected results (illuminance) are shown in Table 1 and FIG. 6B.

TABLE 1

| | φ0 = 45° | | φ0 = 135° | | φ0 = 225° | | φ0 = 315° | |
|---|---|---|---|---|---|---|---|---|
| | −3.6° | 3.6° | −3.2° | 3.2° | −3.4° | 3.4° | −3.4° | 3.4° |
| Black Display | 0.29 | 0.20 | 0.26 | 0.20 | 0.19 | 0.20 | 0.19 | 0.20 |
| Illuminance (1x) | | | | | | | | |
| White Display | 7900 | 7900 | 8100 | 7900 | 7800 | 7900 | 7900 | 8100 |
| Illuminance (1x) | | | | | | | | |
| Contrast Ratio | 27200 | 39500 | 31200 | 39500 | 41100 | 39500 | 41600 | 40500 |

As shown in Table 1 and FIG. 6A, when the azimuth angle φ0 in the tilt direction (orientation axis) with respect to the second substrate 32 of the liquid crystal molecules 33B is 45° or 135° in a counterclockwise direction, if the phase difference compensation element 12 (C plate) is inclined in the same direction as the tilt directions (the azimuth angle φ0 of the orientation axis) of the liquid crystal molecules 33B, the illuminance at the time of back display can be decreased. Particularly, when the azimuth angle φ0 in the tilt direction (orientation axis) with respect to the second substrate 32 of the liquid crystal molecules 33B is 45° in a counterclockwise direction, if the phase difference compensation element 12 is inclined 3.6° in the same direction as the tilt directions (the azimuth angle φ0 of the orientation axis) of the liquid crystal molecules 33B, the illuminance at the time of back display can be most decreased. Moreover, when the azimuth angle φ0 in the tilt direction (orientation axis) with respect to the second substrate 32 of the liquid crystal molecules 33B is 135° in a counterclockwise direction, if the phase difference compensation element 12 is inclined 3.2° in the same direction as the tilt directions (the azimuth angle φ0 of the orientation axis) of the liquid crystal molecules 33B, the illuminance at the time of back display can be most decreased. On the other hand, even though the phase difference compensation element 12 (C plate) is inclined in the same direction as or the direction reverse to the tilt directions (azimuth angle φ0 of orientation axis) of the liquid crystal molecules 33B, the illuminance at the time of white display is the same. Therefore, when the azimuth angle φ0 in the tilt direction (orientation axis) with respect to the second substrate 32 of the liquid crystal molecules 33B is 45° or 135° in a counterclockwise direction, if the phase difference compensation element 12 (C plate) is inclined in the same direction as the tilt directions (the azimuth angle φ0 of the orientation axis) of the liquid crystal molecules 33B, contrast can be improved without the decrease of the illuminance at the time of white display.

As shown in Table 1 and FIG. 6B, when the azimuth angle φ0 in the tilt direction (orientation axis) with respect to the second substrate 32 of the liquid crystal molecules 33B is 225° or 315° in a counterclockwise direction, if the phase difference compensation element 12 (C plate) is inclined in the direction reverse to the tilt directions (the azimuth angle φ0 of the orientation axis) of the liquid crystal molecules 33B, the illuminance at the time of back display can be decreased. Particularly, when the azimuth angle φ0 in the tilt direction (orientation axis) with respect to the second substrate 32 of the liquid crystal molecules 33B is 225° in a counterclockwise direction, if the phase difference compensation element 12 is inclined 3.4° in the direction reverse to the tilt directions (the azimuth angle φ0 of the orientation axis) of the liquid crystal molecules 33B, the illuminance at the time of back display can be most decreased. Moreover, when the azimuth angle φ0 in the tilt direction (orientation axis) with respect to the second substrate 32 of the liquid crystal molecules 33B is 315° in a counterclockwise direction, if the phase difference compensation element 12 is inclined 3.4° in the direction reverse to the tilt directions (the azimuth angle φ0 of the orientation axis) of the liquid crystal molecules 33B, the illuminance at the time of back display can be most decreased. On the other hand, even though the phase difference compensation element 12 (C plate) is inclined in the same direction as or the direction reverse to the tilt directions (azimuth angle φ0 of orientation axis) of the liquid crystal molecules 33B, the illuminance at the time of white display is the same. Therefore, when the azimuth angle φ0 in the tilt direction (orientation axis) with respect to the second substrate 32 of the liquid crystal molecules 33B is 225° or 315° in a counterclockwise direction, if the phase difference compensation element 12 (C plate) is inclined in the direction reverse to the tilt directions (the azimuth angle φ0 of the orientation axis) of the liquid crystal molecules 33B, contrast can be improved without the decrease of the illuminance at the time of white display.

### Application Example to Three Liquid Crystal Devices 3R, 3G, and 3B

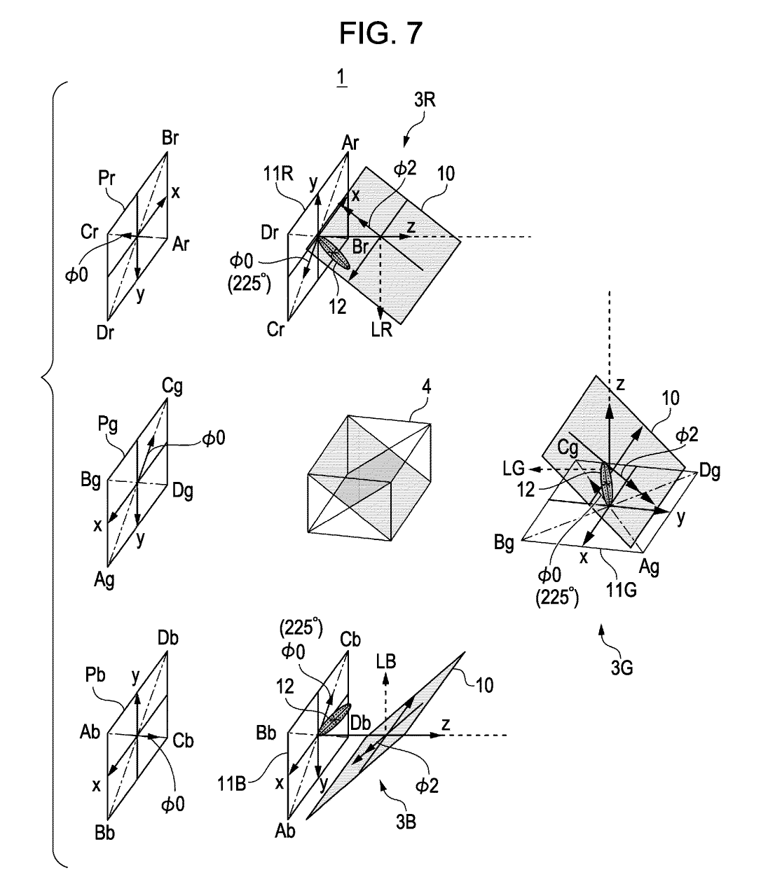

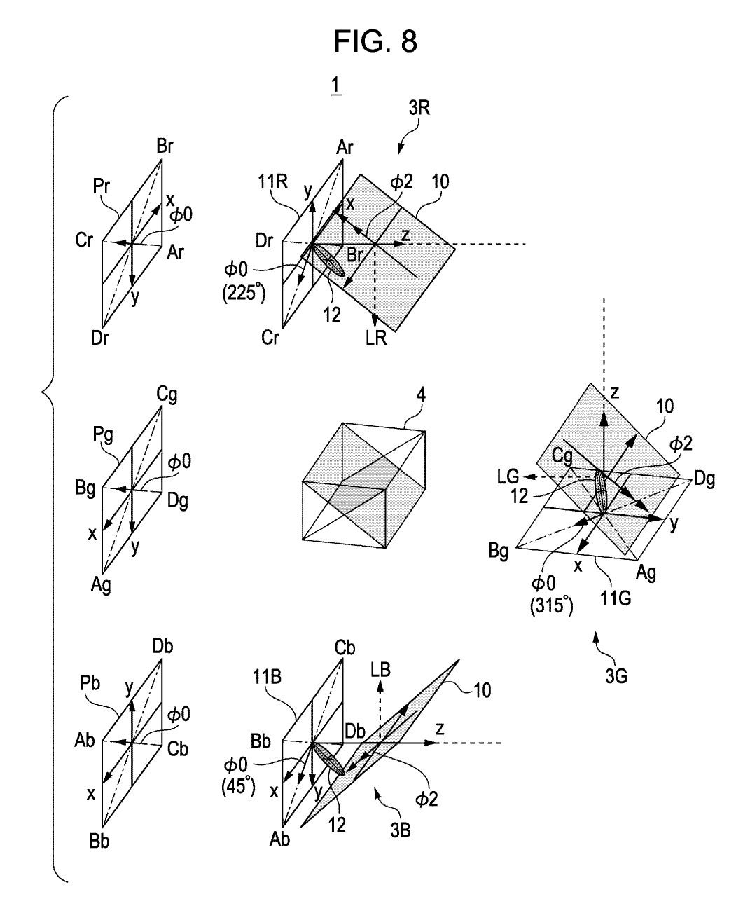

FIG. 7 is an explanatory diagram showing Configuration Example 1 of a projection type display apparatus which includes three liquid crystal devices 3R, 3G, and 3B to which the invention is applied. FIG. 8 is an explanatory diagram showing Configuration Example 2 of the projection type display apparatus which includes three liquid crystal devices 3R, 3G, and 3B to which the invention is applied. In addition, in FIGS. 7 and 8, only the main portions of the liquid crystal device 3 are shown. Moreover, in FIGS. 7 and 8, the images in which the light, which is modulated by each of the liquid crystal devices 3R, 3G, and 3B, is projected from the color synthesizing element 4 are indicated by Pr, Pg, and Pb respectively. In addition, the azimuths corresponding to one another are given as Ar, Br, Cr, and Dr in the liquid crystal panel 11R and the image Pr, the azimuths corresponding to one another are given as Ag, Bg, Cg, and Dg in the liquid crystal panel 11G and the image Pg, and the azimuths corresponding to one another are given as Ab, Bb, Cb, and Db in the liquid crystal panel 11B and the image Pb.

When the projection type display apparatus 1 is configured using the liquid crystal devices 3R, 3G, and 3B to which the invention is applied, the projection type display apparatus 1 shown in FIG. 7 includes only one liquid crystal device of the liquid crystal device in which the phase difference compensation element 12 is disposed in the first inclined orientation and the liquid crystal device in which the phase difference compensation element 12 is disposed in the second inclined orientation.

More specifically, in the liquid crystal devices 3R, 3G, and 3B, even in any of the liquid crystal panels 11R, 11G, and 11B, the tilt directions (azimuth angle φ0 of orientation axis) of the liquid crystal molecules 33B is 225°, and therefore, the phase difference compensation element 12 is inclined in the direction reverse to the tilt directions (azimuth angle φ0 of orientation axis) of the liquid crystal molecules 33B. Accordingly, according to this example, contrast can be improved without the decrease of the illuminance at the time of white display.

In the projection type display apparatus 1 shown in FIG. 8, the plurality of liquid crystal devices 3 include the liquid crystal device in which the phase difference compensation element 12 is disposed in the first inclined orientation and the liquid crystal device in which the phase difference compensation element 12 is disposed in the second inclined orientation, and in the plurality of liquid crystal devices 3 in the projected images, the tilt directions (azimuth angle φ0 of orientation axis) of the liquid crystal molecules 33B are the same. More specifically, among three liquid crystal devices, in two liquid crystal devices 3R and 3B which makes light incident from the direction relatively opposite to the color synthesizing element 4 including the dichroic prism, the liquid crystal device in which the phase difference compensation element 12 is disposed in the first inclined orientation and the liquid crystal device in which the phase difference compensation element 12 is disposed in the second inclined orientation are included. In addition, in two liquid crystal devices 3R and 3B, the tilt directions (azimuth angle φ0 of orientation axis) of the liquid crystal molecules 33B differ by 180°.

For example, in the liquid crystal device 3R, the tilt directions (azimuth angle φ0 of orientation axis) of the liquid crystal molecules 33B are 225°, and the phase difference compensation element 12 is disposed in a second inclined orientation. On the other hand, in the liquid crystal device 3B, the tilt directions (azimuth angle φ0 of orientation axis) of the liquid crystal molecules 33B are 45°, and the phase difference compensation element 12 is disposed in a first inclined orientation. Moreover, in the liquid crystal device 3G, the tilt directions (azimuth angle φ0 of orientation axis) of the liquid crystal molecules 33B are 315°, and in the two liquid crystal devices 3R and 3B, the tilt directions (azimuth angle φ0 of orientation axis) of the liquid crystal molecules 33B differ by 90°. Accordingly, in the images Pr, Pg, and Pb, the positions of the tilt directions of the liquid crystal molecules 33B are the same as one another. Therefore, according to this example, contrast can be improved without the decrease of the illuminance at the time of white display, a decrease and prevention of coloring when a stripe pattern or the like is displayed can be achieved.

### Other Electronic Apparatus

In the above-described embodiment, the projection type display apparatus 1 is exemplified as the electronic apparatus which uses the liquid crystal device according to the invention. However, the invention may be applied to a direct viewing type display configuring the display portion in the electronic apparatus such as a head mount display (HMD) or a view finder (EVF) or the electronic apparatus such as a personal digital assistant.

This application claims priority from Japanese Patent Application No. 2011-229470 filed in the Japanese Patent Office on Oct. 19, 2011, the entire disclosure of which is hereby incorporated by reference in its entirely.

What is claimed is:

1. A liquid crystal device comprising:
a liquid crystal panel which includes a first translucent substrate, a second substrate which is disposed so as to be opposite to the first substrate and includes a reflecting layer which reflects light incident from the first substrate toward the first substrate side, and a liquid crystal layer which is provided between the first substrate and the second substrate while having negative dielectric anisotropy and in which liquid crystal molecules are inclined to a normal line direction with respect to a substrate surface of the first substrate and a substrate surface of the second substrate;
a wire grid polarization beam splitter which is disposed so as to be inclined with respect to the first substrate and the second substrate in the side of the first substrate opposite to the second substrate; and
a phase difference compensation element which is disposed between the first substrate and the wire grid polarization beam splitter and in which an optical axis has refractive index anisotropy of negative uniaxial properties along the thickness direction,
wherein when a tilt direction in which the liquid crystal molecules are inclined with respect to the second substrate has an azimuth of 45° or 135° in a counterclockwise direction with respect to a direction in which the wire grid of the wire grid polarization beam splitter extends when the liquid crystal panel is viewed from the wire grid polarization beam splitter side, the phase difference compensation element is disposed in a second inclined orientation which is inclined so that a portion positioned in the tilt direction side based on an axis line forming 90° with respect to the tilt direction approaches the liquid crystal panel and a portion positioned in the side opposite to the tilt direction is separated from the liquid crystal panel, and
when the tilt direction has an azimuth of 225° or 315° in a counterclockwise direction with respect to a direction in which the wire grid extends, the phase difference compensation element is disposed in a first inclined orientation which is inclined so that a portion positioned in the tilt direction side based on the axis line is separated from the liquid crystal panel and a portion positioned in the side opposite to the tilt direction approaches the liquid crystal panel.

2. A liquid crystal device comprising:
a liquid crystal panel which includes a first translucent substrate, a second substrate which is disposed so as to be opposite to the first substrate and includes a reflecting layer which reflects light incident from the first substrate toward the first substrate side, and a liquid crystal layer which is provided between the first substrate and the second substrate while having negative dielectric anisotropy and in which liquid crystal molecules are inclined to a normal line direction with respect to a substrate surface of the first substrate and a substrate surface of the second substrate;
a wire grid polarization beam splitter which is disposed so as to be inclined with respect to the first substrate and the second substrate in the side of the first substrate opposite to the second substrate; and
a phase difference compensation element which is disposed between the first substrate and the wire grid polarization beam splitter and in which an optical axis has refractive index anisotropy of negative uniaxial properties along the thickness direction,
wherein a tilt direction in which the liquid crystal molecules are inclined with respect to the second substrate has an azimuth of 45° or 135° in a counterclockwise direction with respect to a direction in which the wire grid of the wire grid polarization beam splitter extends when the liquid crystal panel is viewed from the wire grid polarization beam splitter side, and
the phase difference compensation element is disposed in a first inclined orientation which is inclined so that a portion positioned in the tilt direction side based on an axis line forming 90° with respect to the tilt direction approaches the liquid crystal panel and a portion positioned in the side opposite to the tilt direction is separated from the liquid crystal panel.

3. A liquid crystal device comprising:
a liquid crystal panel which includes a first translucent substrate, a second substrate which is disposed so as to be opposite to the first substrate and includes a reflecting layer which reflects light incident from the first substrate toward the first substrate side, and a liquid crystal layer which is provided between the first substrate and the second substrate while having negative dielectric anisotropy and in which liquid crystal molecules are inclined to a normal line direction with respect to a substrate surface of the first substrate and a substrate surface of the second substrate;
a wire grid polarization beam splitter which is disposed so as to be inclined with respect to the first substrate and the second substrate in the side of the first substrate opposite to the second substrate; and
a phase difference compensation element which is disposed between the first substrate and the wire grid polarization beam splitter and in which an optical axis has refractive index anisotropy of negative uniaxial properties along the thickness direction,
wherein a tilt direction in which the liquid crystal molecules are inclined with respect to the second substrate has an azimuth of 225° or 315° in a counterclockwise direction with respect to a direction in which the wire grid of the wire grid polarization beam splitter extends when the liquid crystal panel is viewed from the wire grid polarization beam splitter side, and
the phase difference compensation element is disposed in a second inclined orientation which is inclined so that a portion positioned in the tilt direction side based on an axis line forming 90° with respect to the tilt direction is separated from the liquid crystal panel and a portion positioned in the side opposite to the tilt direction approaches the liquid crystal panel.

4. The liquid crystal device according to claim 1,
wherein the wire grid extends so as to be parallel to the substrate surface of the first substrate and the substrate surface of the second substrate.

5. The liquid crystal device according to claim 4,
wherein a polarization separation surface on which the wire grid is formed in the wire grid polarization beam splitter is disposed in an inclined orientation in which a side of 90° in a counterclockwise direction with respect to the direction in which the wire grid extends approaches the liquid crystal panel and a side of 270° in a counterclockwise direction with respect to the direction in which the wire grid extends is separated from the liquid crystal panel when the wire grid polarization beam splitter is viewed from the side opposite to the liquid crystal panel side.

6. An electronic apparatus comprising the liquid crystal device according to claim 1.

7. An electronic apparatus comprising the liquid crystal device according to claim 2.

8. An electronic apparatus comprising the liquid crystal device according to claim 3.

9. A projection type display apparatus comprising:
the liquid crystal device according to claim 1 which is plural in number;
a light source which emits light supplied to the plurality of liquid crystal devices;
a color synthesizing optical system which synthesizes each light which is modulated by a plurality of the liquid crystal devices; and
a projection optical system which projects the light synthesized by the color synthesizing optical system,
wherein the plurality of liquid crystal devices includes only one liquid crystal device of a liquid crystal device in which the phase difference compensation element is disposed in the first inclined orientation and a liquid crystal device in which the phase difference compensation element is disposed in the second inclined orientation.

10. A projection type display apparatus comprising:
the liquid crystal device according to claim 1 which is plural in number;
a light source which emits light supplied to a plurality of the liquid crystal devices;
a color synthesizing optical system which synthesizes each light which is modulated by the plurality of liquid crystal devices; and
a projection optical system which projects the light synthesized by the color synthesizing optical system,
wherein the plurality of liquid crystal devices includes a liquid crystal device in which the phase difference compensation element is disposed in the first inclined orientation and a liquid crystal device in which the phase difference compensation element is disposed in the second inclined orientation, and
the tilt directions in the plurality of liquid crystal devices in the image which is projected from the projection optical system are the same azimuth.

11. The projection type display apparatus according to claim 10,
wherein the color synthesizing optical system includes a dichroic prism,
two liquid crystal devices which makes light incident from the direction relatively opposite to the dichroic prism among the plurality of liquid crystal devices include the liquid crystal device in which the phase difference compensation element is disposed in the first inclined orientation and the liquid crystal device in which the phase difference compensation element is disposed in the second inclined orientation, the tilt directions in two liquid crystal devices differ by 180°, and
in the liquid crystal device which makes the light incident from other direction with respect to the dichroic prism, the tilt directions with respect to the two liquid crystal devices differ by 90°.
